(19) United States
(12) Patent Application Publication
(10) Pub. No.: US 2009/0307046 A1
(43) Pub. Date: Dec. 10, 2009

(54) Contracting method and apparatus for services

(76) Inventor: Don Taylor, Murray, UT (US)

Correspondence Address: MARCUS G THEODORE, PC, 466 SOUTH 500 EAST, SALT LAKE CITY, UT, 84102, US

(21) Appl. No.: 12/157,027

(22) Filed: Jun. 6, 2008

(51) Int. Cl. G06Q 10/00; G06Q 20/00; G06Q 30/00; G06Q 40/00

(52) U.S. Cl. 705/9; 705/80; 705/40

(57) ABSTRACT

An electronic contracting method and apparatus for the purchase of pre-funded future services to equalize the bargaining positions of the parties and then deliver payment in accordance with the negotiated service contract terms.

### BACKGROUND OF THE INVENTION

1. Field of Invention

The present invention relates to contracting methods. In particular, it relates to an electronic contracting method and apparatus for services where there is a separation of time between the agreement and delivery of services.

2. Description of Related Art

Various contracting methods are known in the art. Moritsu et al., U.S. Pat. No. 6,947,911 issued Sep. 20, 2005 discloses an electronic contracting method and system to collect data concerning contracting parties and the terms to make an electronic contract for the provision of a commodity or service, which is then generated and signed electronically. It does not address or equalize the bargaining positions of the contracting parties or providing funds for payment.

Berry et al., U.S. Pat. No. 7,333,996 issued Feb. 19, 2008 discloses a system and method for managing contract data using a decentralized execution system from a procurement contract management system. This contract data system focuses on accounting for the terms of a negotiated contract, but does not address equalizing the bargaining power of the parties negotiating their terms of the contract or providing funds for payment. Nor does it recognize the distinctions between service contracts and contracts for the sale of goods, which are controlled by the Uniform Commercial Code adopted by all states.

The UCC requires the parties to contracts for the sale of goods to act in good faith where quantity is to be measured by the requirements of the purchaser, or, in the case of output contracts, the output of the seller. The UCC also contains contract warranty terms as to the quality of the goods, terms of shipment, and allocation of risks of loss in transit, the term of the contract, and other commercial terms. No such universal commercial code exists with respect to service contracts.

Services are intangible and insubstantial; they cannot be handled, smelled, tasted, heard, etc. There is neither potential nor need for storage and they are said to be inseparable and perishable. Because services are difficult to conceptualize, marketing them requires creative visualization to effectively evoke a concrete image in the customer's mind. From the customer's point of view, this characteristic makes it difficult to evaluate or compare services prior to experiencing the service delivery. They are perishable, and unsold service time is a lost economic opportunity. For example a doctor who is booked for only two hours a day cannot later work those hours—she has lost her economic opportunity. Other service examples are airplane seats (once the plane departs, those empty seats cannot be sold), and theatre seats (sales end at a certain point). There is a lack of transportability as services tend to be consumed at the point of “production” although this does not apply to outsourced business services. Services are regarded as heterogeneity or lack of homogeneity and are typically modified for each consumer or each new situation. Mass production of services is very difficult. This can be seen as a problem of inconsistent quality. Both inputs and outputs to the processes involved providing services are highly variable, as are the relationships between these processes, making it difficult to maintain consistent quality. There is labor intensity as services usually involve considerable human activity, rather than a precisely determined process. Human resource management is important. The human factor is often the key success factor in service industries. It is difficult to achieve economies of scale or gain dominant market share. There are demand fluctuations and it can be difficult to forecast demand which is also true of many goods. Demand can vary by season, time of day, business cycle, etc. There is buyer involvement as most service provision requires a high degree of interaction between service consumer and service provider. There is a client-based relationship based on creating long-term business relationships. Accountants, attorneys, and financial advisers maintain long-term relationships with their clients for decades. These repeat consumers refer friends and family, helping to create a client-based relationship. In addition, services often entail the provision of associated goods with the services, such as construction contracts, where in addition to labor, materials are also required as part of the job.

According to Wikipedia, the clear-cut, consistent, generic definition of the service term reads as follows:
“A service is a set of benefits delivered from the accountable service provider, mostly in close coaction with his service suppliers, generated by the functions of technical systems and/or by distinct activities of individuals, respectively, commissioned according to the needs of his service consumers by the service customer from the accountable service provider, rendered individually to the authorized service consumers on their dedicated request, and, finally, utilized by the requesting service consumers for executing and/or supporting their day-to-day business tasks or private activities.”
For clarity, services must be specified by the following:
“1. Service Consumer Benefits describe the (set of) benefits which are callable, receivable and effectively utilizable for any authorized service consumer and which are provided to him as soon as he requests the offered service. The description of these benefits must be phrased in the terms and wording of the intended service consumers.
2. Service-specific Functional Parameters specify the functional parameters which are essential and unique to the respective service and which describe the most important dimension of the service output, e.g. maximum e-mailbox capacity per registered and authorized e-mail service consumer.
3. Service Delivery Point describes the physical location and/or logical interface where the benefits of the service are made accessible, callable and receivable to the authorized service consumers. At this point and/or interface, the preparedness for service delivery can be assessed as well as the effective delivery of the service itself can be monitored and controlled.
4. Service Consumer Count specifies the number of intended, identified, named, registered and authorized service consumers which are allowed and enabled to call and utilize the defined service for executing and/or supporting their business tasks or private activities.
5. Service Readiness Times specify the distinct agreed times of day when
the described service consumer benefits are
   accessible and callable for the authorized service consumers at the defined service delivery point
   receivable and utilizable for the authorized service consumers at the respective agreed service level
all service-relevant processes and resources are operative and effective
all service-relevant technical systems are up and running and attended by the operating team
the specified service benefits are comprehensively delivered to any authorized requesting service consumer without any delay or friction.
The time data are specified in 24 h format per local working day and local time, referring to the location of the intended service consumers.
6. Service Support Times specify the determined and agreed times of day when the usage and consumption of the contracted services is supported by the service desk team for all identified, registered and authorized service consumers within the service customer's organizational unit or area. The service desk is the single point of contact for any service consumer inquiry regarding the contracted and delivered services. During the defined service support times, the service desk can be reached by phone, e-mail, web-based entries and/or fax, respectively. The time data are specified in 24 h format per local working day and local time, referring to the location of the intended service consumers.
7. Service Support Languages specifies the languages which are spoken by the service desk team(s) to the service consumers calling them.
8. Service Fulfillment Target specifies the service provider's promise of effective and seamless delivery of the defined benefits to any authorized service consumer requesting the service within the defined service times. It is expressed as the promised minimum ratio of the counts of successful individual service deliveries related to the counts of called individual service deliveries. The effective service fulfillment ratio can be measured and calculated per single service consumer or per consumer group and may be referred to different time periods (workday, calendar week, work month, etc.)
9. Maximum Impairment Duration per Incident specifies the allowable maximum elapsing time [hh:mm] between
the first occurrence of a service impairment, i.e. service quality degradation or service delivery disruption, whilst the service consumer consumes and utilizes the delivered service,
the full resumption and complete execution of the service delivery to the content of the affected service consumer.
10. Service Delivering Duration specifies the promised and agreed maximum period of time for effectively delivering all specified service consumer benefits to the requesting service consumer at the defined service delivery point.
11. Service Delivery Unit specifies the basic portion for delivering the defined service consumer benefits. The service delivery unit is the reference and mapping object for all cost for service generation and delivery as well as for charging and billing the consumed service volume to the service customer who has ordered the service delivery.
12. Service Delivering Price specifies the amount of money the service customer has to pay for the consumption of distinct service volumes. Normally, the service delivering price comprises two portions
a fixed basic price portion for basic efforts and resources which provide accessibility and usability of the service delivery functions, i.e. service access price
a price portion covering the service consumption based on
   fixed flat rate price per authorized service consumer and delivery period without regard on the consumed service volumes,
   staged prices depending on consumed service volumes,
   fixed price per particularly consumed service delivering unit.”

Services often include the provisions of materials as part of a job. These related materials may or may not be separately priced out as part of the job. However, they are integral to a service contract, and will hereinafter simply be referred to as “services”.

As can be seen, the terms of a service contract are difficult to standardize and value and are therefore subject to wide variation as to value, and must therefore be based on the parties' negotiations. Consequently, service contract terms are largely determined by the strength of the parties' respective bargaining positions and the types of services to be contracted.

Without specific service contract terms, disputes often arise. To avoid this, may states mandate the use of written contracts in particular areas. For example, home improvement contract requirements in Massachusetts require all contracts over $1,000.00 to be in writing. If contractors violate this provision, their license may be suspended or revoked, and they can be fined or face criminal prosecution. The Office of the Consumer Affairs & Business Regulation website http://www.mass.gov/?pageID=ocaterminal&L=5&L0=Home&L=recommends that the contractor service contract contain:

1. The identification of the contractor, including the contractor's registration number;

2. The total price of the work,

3. The payment schedule,

4. A provision for changes or “extras”,

5. A detailed list of specifications/materials,

6. Start and Completion dates,

7. A copy of the Contractor's insurance,

8. A permit notice warning that if the purchaser secures their own building permit or deals with unregistered contractors, they will not be eligible for the Guaranty Fund,

9. A 3-day cancellation notice, informing the purchaser of the right to cancel the contract if the contract were signed at home, or at a place other than at the contractor's office or business; and

10. Other details particular to the job.

Note these safeguards do not apply to smaller jobs under $1,000.00 or to other disciplines. Also note that they do not equalize the bargaining positions of the parties, which are typically negotiated between a skilled contractor and an unsophisticated first time buyer of home improvements. Consequently, the contractor will often require onerous payment terms in the event of default, and may even surcharge the job to recover the default payment costs from all of his jobs.

In other service fields, such as the law, the terms of service are nebulous and controlled by the lawyer delivering them in accordance with his timetable typically on an hourly basis. He or she may also require a retainer, which is placed in a lawyer controlled trust account. Consequently, the client retains no financial incentives for a job to be delivered timely or on budget. In addition, unscrupulous lawyers illegally dip into this trust fund and then fail to deliver the services.

An example of the greatest discrepancy in the bargaining position of parties to a service contract is contracting with the federal government. In this case, the supplier of the services is at a distinct disadvantage as the Government purchases services via elaborate contract bid requirements solely determined by the Government, and offered on a take or leave it basis. This bargaining discrepancy is due to the Government's substantial ability to pay for services ordered.

Cited for general interest is Kasai, U.S. Pat. No. 6,728,686 issued Apr. 27, 2004 discloses an electronic money holding device and electronic money automatic payment method using IC card storage of funds, which are dispersed in accordance with the payment terms of a negotiated contract. This electronic payment system is not involved in the negotiation of the terms of a contract, and also does not address equalizing the bargaining power of the parties negotiating the terms of a contract.

Consequently, there remains a need for a service contracting method, which levels the bargaining positions of the parties and secures payment in accordance with the negotiated terms. The invention described below provides such an invention and method of using it.

### SUMMARY OF THE INVENTION

The present invention comprises a method and apparatus for purchasing services on a pre-funded fixed cost basis with a service provider. This equalizes the bargaining position of the purchaser of services to negotiate more favorable terms from a service provider by avoiding added collection, lien and attorney's fee costs to cover uncertainty of payment, as well as provide financial payment incentives for timely delivery.

The method comprises electronically depositing funds in an account set up by a purchaser of services to be received in the future, which is controlled by a third party funding computer to secure payment for contracted services. The terms of a funded service contract between a service provider and the purchaser of services are then negotiated, reduced to fixed amounts with dates of completion and distribution, and entered electronically into the funding computer holding the purchaser of services' funds, which cannot be withdrawn without mutual agreement of both parties. As the services are provided by the service provider, their amounts are entered into the funding computer securing payment for the services provided by either party and notice is given to the purchaser of services. The funds are then electronically distributed to the service provider in accordance with the terms of the service contract upon approval by the purchaser of the services.

The scope of work terms typically entered into the funding computer include:
i. tasks to be provided by the service provider.
ii. timeline for task completion
iii. milestones to be met by the service provider
iv. associated goods to be provided along with the services by the service provider
v. contract time period, including start and termination dates
vii. fixed prices for the services and related goods to be provided
viii. dates for full or partial payment

The funding computer is operated and administered by an electronic third party funding source who acts as the service administrator to distribute funds and resolve any contract disputes as to the performance of the services, such as the PayPal type system presently used for the purchase of goods. PayPal is an e-commerce business allowing payments and money transfers to be made through the Internet. It serves as an electronic alternative to traditional paper methods such as cheques and money orders. It performs payment processing for online vendors, auction sites, and other corporate users, for which it charges a fee. It sometimes also charges a transaction fee for receiving money (a percentage of the amount sent plus an additional fixed amount). The fees charged depend on the currency used, the payment option used, the country of the sender, the country of the recipient, the amount sent and the recipient's account type. On Oct. 3, 2002, PayPal became a wholly owned subsidiary of eBay. In the event of disputes, these may be referred to arbitration or resolved in court. Funds are then disbursed in accordance with the terms of the dispute resolution order.

However, contrary to The PayPal Buyer Protection Policy, purchasers of services using applicant's method may not unilaterally cancel their deposits, as is done with PayPal credit card purchases of goods. PayPal states its Seller Protection Policy is “designed to protect sellers against claims by buyers of unauthorized payments and against claims of non-receipt of any merchandise”. The Seller Protection Policy excludes services as “Intangible goods”.

Applicant's method for contracting and purchasing of services may include security measures similar to those adopted by other e-commerce businesses allowing funds transfers through the internet. In early 2007, PayPal introduced a security key that adds an additional layer of protection when logging into PayPal or eBay accounts. A user account tied to a security key has a modified login process; once the user enters their normal login ID and password, they are prompted to press a button on the security key, and then enter the six-digit number generated by the key to complete the login process. A PayPal security key generates a six-digit temporary login code to authenticate the user.

This two-factor authentication prevents an account from being compromised by a malicious third party without access to the physical security key. If a user loses their security key, they can authenticate by providing their credit card or bank account number listed on their account.

For service contracts requiring a licensed service provider, the funding computer may be configured and programmed to access a state or federal licensing data base of licensed contractors to computer qualify the service provider for provision of services.

The funds controlled by the funding computer may be provided by electronic transfer or a bank deposit, or funding source in accordance with a bank line extended to the purchaser. Alternatively, the funds may be provided by the purchaser authorizing debits against his account for the services and related goods provided. This immediate funding feature allows change orders to be entered electronically by the service provider and accepted by the purchaser of services and immediately funded.

The present invention was developed out of the need for accountability in a service provider-service purchaser relationship. The purchaser and the service provider objectives are to provide some type of protection for their respective positions. Prior to this invention this was impossible. The invention provides a protection lock for both purchaser and the service provider. Their needs are:

### Purchaser:

1. Wants control of the job.
2. This is not possible unless money is controlled.

### Service Provider:

1. Wants payment for the job
2. Payments need to be paid in a timely manner to take care of job commitments (Payrolls, Supplies, Subcontractor Costs Etc.)
   Historically, these needs were in direct conflict with each other, which leads to contractors not getting paid and purchasers not receiving job satisfaction. An example of how the present invention resolves these conflicts is accomplished by placing the two sets of functioning operations together for an adequate solution. This methodology is outlined as follows:
1. An e-commerce business account allowing payments and money transfers to be made through the Internet online third party banking system is set up by the service purchaser that documents the receipt of payments deposited for purchase of services. The funds deposited are released by the third party banking system conditioned on the services and related products being delivered satisfactorily to the purchaser who then authorizes release of the funds.
2. A computer system is associated with the online third party banking system to document the receipt and disbursement of payments on a scheduled basis or in accordance with the contract terms entered into a computer. Payments thus can be disbursed either in stages or upon completion. The computer allows a service provider access to verify deposits of payments, which the purchaser is withholding until the work is completed. This allows the service provider to schedule work around those purchasers who have provided payment security for delivered services. This also provides incentives to the purchaser to approve and disburse funds timely to complete the job.

### Set Up of System

The apparatus of the invention uses the same types of equipment used for electronic banking, also known as electronic fund transfer (EFT). It uses a computer and electronic technology as a substitute for checks and other paper transactions. EFT's are initiated through devices such as cards or codes that you use to gain access to the account. USPTO Application #20060112011, entitled “Electronic banking system” discusses the general components for an automated electronic banking system for initiating and automatically processing monetary transactions. In addition to the electronic components discussed, means for allowing the purchaser to deposit funds to secure payment for services are included. The apparatus also includes initiating means for maintaining a transaction record and permitting a remotely located customer of a bank to selectively initiate a monetary transaction request for automated processing. A bank host server is adapted for automatically receiving and processing the monetary transaction request. A computer network in data communication is set up between the bank host server means and the initiating means for transmitting the payment transaction request from the customer's initiating means to the to bank host server. Interface means are located between the initiating means and the computer network for automatically interfacing the initiating means to the bank host server, and for converting the monetary transaction request into a readable form compatible with the bank host server, wherein the customer's initiating means periodically receives in response from the bank host server confirmation data for permitting the initiating means to automatically reconcile the transaction record on a daily basis.

These electronic components are adapted with secure access codes for both the purchaser of services and provider of services to access information as to the funds in the account. These access codes uniquely identify the purchaser of services and the service provider authorizing their access to the system. The terms of the deposit may be modified to allow additional deposits to be made by the purchaser of services to cover additional add on services and the related goods thereto, using direct deposits, pay-by-phone systems, and personal computer banking.

Thus configured the contracting apparatus allows the purchaser of services to electronically authorize change orders and deposit funds in lump sums or in increments. It locks and secures the relationship between the purchaser of services and the service provider by deposit and verification of funds and services provided. It allows the assignment of secure identification numbers for the purchaser of services and services provider to track the funds in accordance with industry standards preventing unauthorized access. In addition, the apparatus may include positioning codes on software programs controlling the funding computer to handle various functions.

The contracting apparatus thus allows the owner to control his monies, until the services and related goods are delivered. It does not allow owner to move money out of the account unless positioning of codes warrants said movement, or the service provider consents to it. However, it allows the purchaser of services to receive invoices to verify supplies were purchased and subcontractors paid.

Conversely, the contracting apparatus gives the service provider a documented history of the work performed for litigation or arbitration purposes as well as assurances that funds are on deposit to enable him or her to prepare online immediate work orders, which are sent electronically to the purchaser of services for approval. The invention then allows the purchaser of services to enter approvals of work orders electronically to document the terms of a transaction.

For service providers who deal with a number of purchasers of services, the invention allows them to enter code and verify for all customers amounts paid into the secured account. This allows the service provider to set up work on hand process for monies that are in the system; thereby enabling service provider to meet job obligations.

The invention thus provides a service contracting method, which levels the bargaining positions of the parties and delivers timely payment upon completion of the service contract in accordance with its negotiated terms. It avoids misunderstandings, which arise everyday regarding service contract terms. The invention brings honesty, accountability and integrity back to any timed service installation relationship. It allows the purchaser of services job satisfaction prior to the movement of any monies, including at the end of the job any final punch lists. It also allows the service provider to move monies back into service purchaser's account if the need warrants.

### BRIEF DESCRIPTION OF THE DRAWINGS

FIG. 1 is a flow chart of a preferred embodiment of the method of the invention.

FIG. 1a is a continuation of the flow chart of FIG. 1.

### DESCRIPTION OF THE ILLUSTRATED EMBODIMENTS

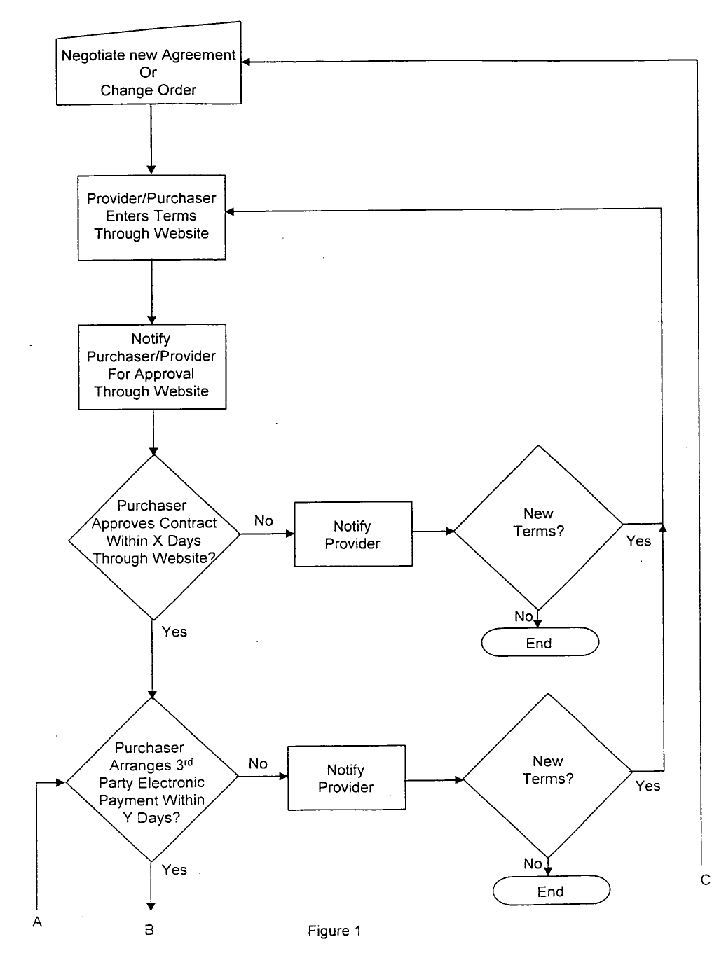

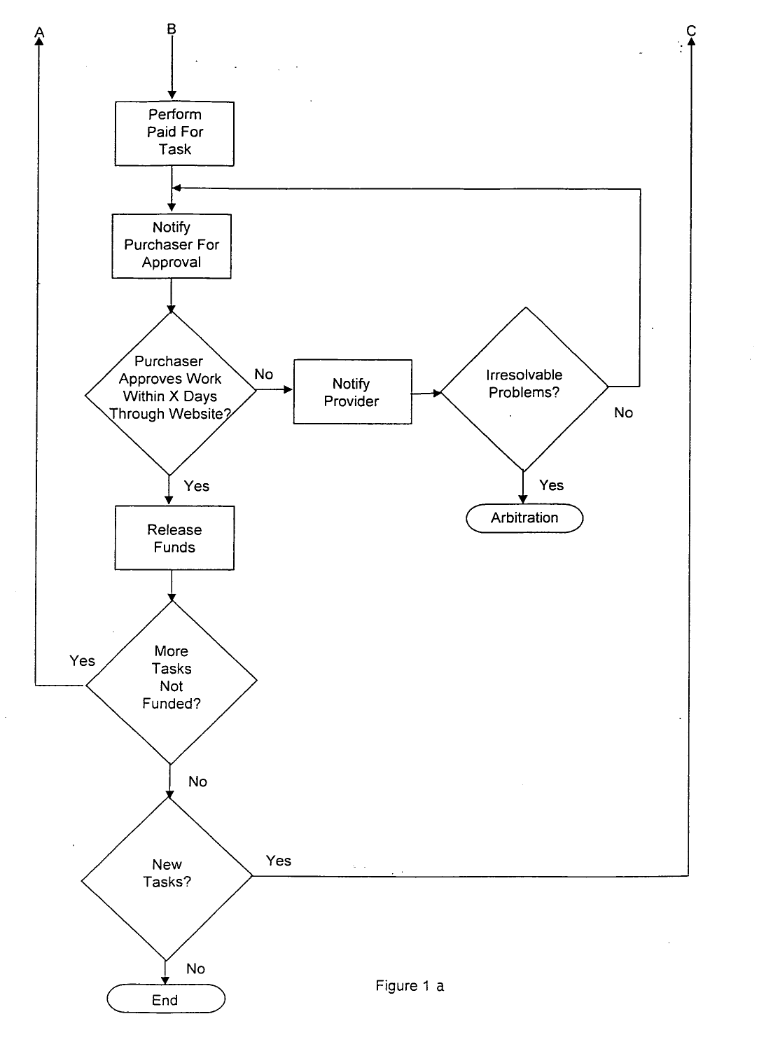

FIGS. 1 and 1a illustrate a flow chart of a preferred method of the invention. It comprises negotiating a new service contract purchase agreement or a change order in terms of fixed amounts to be disbursed at specific times. The service provider or purchaser in this illustration enters the contract terms into a computer through a website, which notifies the Purchaser or Provider of the terms on the website for approval. Terms are then accepted or renegotiated by the Purchaser.

The Purchaser then arranges for a Third Party banking source to establish an electronic funding account to distribute funds in accordance with the contract terms to the Provider as services are performed. The Provider, after performance, notifies the Purchaser for approval and payment. The Purchaser then approves the tasks and directs the Third Party banking source to release the funds to the Provider for work completed.

Upon release of the last funds, if more tasks are to be provided, the process begins all over with the negotiation of a new agreement or change order.

Although the illustrated embodiment shows the terms of the new agreement or change order negotiated before being entered through a website, they may also be negotiated after the establishment of an electronic funding account with a Third Party banking source for payment of future services. In this second embodiment, the terms of the contract are entered into the electronic banking account with respect to how payments are to be disbursed for services rendered.

The above description and specification should not be construed as limiting the scope of the claims but as merely providing illustrations of some of the presently preferred embodiments of this invention. Thus, the claims themselves contain those features deemed essential to the invention.

We claim:

1. An electronic contracting method for the purchase of services comprising:
a. electronically depositing funds into an account set up by a purchaser of services with a third party electronic banking system for payment of services to be received in the future; the funds controlled by a third party banking funding computer to disburse funds and track payments for delivered contracted services provided by a service contractor, and cannot be withdrawn without mutual agreement of both the purchaser and provider of services,
b. negotiating terms of a funded service contract scope of work with a service provider to provide the services in terms of fixed amounts and dates of delivery,
c. electronically entering the terms of the service contract into the funding computer holding the purchaser of services' funds, and
d. electronically distributing funds to the service provider approved by the purchaser in accordance with the terms of the service contract for services provided.

2. An electronic contracting method for the purchase of services according to claim 1, wherein the scope of work includes:
i. tasks to be provided by the service provider.
ii. timeline for task completion
iii. milestones to be met by the service provider
iv. associated goods to be provided along with the services by the service provider
v. contract time period, including start and termination dates
vii. fixed price for the services and related goods provided
viii. dates of full or partial payment
ix. purchaser's instructions as to when final disbursements may be made
d. computer entering the services provided,
e. electronically distributing funds by the third party to the service provider for services provided.

3. An electronic contracting method for the purchase of services according to claim 1, wherein the provider of services electronically enters change orders, which are authorized by the purchaser of services who deposits funds in lump sums or in increments to secure payment for additional services.

4. An electronic contracting method for the purchase of services according to claim 1, wherein the purchaser of services and provider of services assigned unique access codes, and the funding computer is adapted to provide secure access upon entry of the access codes to information as to the status of funds held in the account.

5. An electronic contracting method for the purchase of services according to claim 4, wherein the provider of services may access the funding computer to schedule jobs based on the status of finds on deposit.

6. An electronic contracting method for the purchase of services according to claim 1, including having adapting the funding computer to access and check a state and federal licensing data base to insure that the provider of services is currently licensed and in good standing.

7. An electronic contracting method for the purchase of services according to claim 1, wherein the third party banking system acts as a service administrator to resolve any contract disputes as to the performance of the service contract.

8. An electronic contracting method for the purchase of services according to claim 1, wherein the funds are provided by a bank or funding source in accordance with a bank line extended to the purchaser of services.

9. An electronic contracting method for the purchase of services according to claim 1, wherein the funds are provided by the purchaser of services.

10. An electronic contracting method for the purchase of services comprising:
a. negotiating terms of a funded service contract scope of work with a service provider to provide services in terms of fixed amounts and dates of delivery, including:
i. tasks to be provided by the service provider.
ii. timeline for task completion
iii. milestones to be met by the service provider
iv. associated goods to be provided along with the services by the service provider
v. contract time period, including start and termination dates
vii. fixed price for the services and related goods provided
viii. dates of full or partial payment
ix. purchaser's instructions as to when final disbursements may be made
b. electronically entering the terms of the service contract into an electronic banking account set up by a purchaser of services with a third party banking system for payment of services to be received in the future; the third party banking account adapted to electronically disburse funds deposited by the purchaser of services to a service provider for delivered contracted services, and cannot be withdrawn without mutual agreement of both the purchaser and provider of services, and
c. electronically distributing funds to the service provider approved by the purchaser of services in accordance with the terms of the service contract for services provided.

11. An electronic contracting method for the purchase of services according to claim 10, wherein the purchaser of services and provider of services assigned unique access codes, and the funding computer is adapted to provide secure access upon entry of the access codes to information as to the status of funds held in the account.

12. An electronic contracting apparatus for the purchase of services comprising:
a. an electronic banking system controlled by a third party operating a funding computer,
b. means to electronically deposit funds into an account in the electronic banking system set up by a purchaser of services to secure payment for future services; the funds controlled by the funding computer to disburse funds and track payments for delivered contracted services provided by a service contractor, and cannot be withdrawn without mutual agreement of both the purchaser and provider of services,
c. means for entering terms of a negotiated funded service contract scope of work between the purchaser and provider of services in terms of fixed amounts and dates of delivery and distribution into the funding computer holding the purchaser of services' funds, and
d. means for electronically distributing funds to the service provider for services provided and approved by the purchaser of services in accordance with the terms of the service contract.

13. An electronic contracting apparatus for the purchase of services according to claim 12, wherein the scope of work includes:
i. tasks to be provided by the service provider.
ii. timeline for task completion
iii. milestones to be met by the service provider
iv. associated goods to be provided along with the services by the service provider
v. contract time period, including start and termination dates
vii. fixed price for the services and related goods provided
viii. dates of full or partial payment
ix. purchaser's instructions as to when final disbursements may be made.

14. An electronic contracting apparatus for the purchase of services according to claim 13, including means allowing the provider of services to enter change orders and the purchaser of services to electronically authorize the change orders and deposit funds in lump sums or in increments to secure payment for additional services.

15. An electronic contracting apparatus for the purchase of services according to claim 13, wherein both the purchaser of services and provider of services are assigned unique access codes, and the funding computer is adapted to provide secure access upon entry of the access codes to information as to the status of funds held in the account.

16. An electronic contracting apparatus for the purchase of services according to claim 15, wherein the provider of services may access the funding computer to schedule jobs based on information as to the funds on deposit.

17. An electronic contracting apparatus for the purchase of services according to claim 13, wherein the funding computer is adapted to access and check state and federal licensing data bases to insure that the provider of services is currently licensed and in good standing.

18. An electronic contracting apparatus for the purchase of services according to claim 13, wherein the third party banking system acts as a service administrator to resolve any contract disputes as to the performance of the service contract and enters a decision into the funding computer directing dispersal of funds in accordance with its decision.

19. An electronic contracting apparatus for the purchase of services according to claim 13, wherein the funds are provided by a bank or funding source in accordance with a bank line extended to the purchaser of services.

20. An electronic contracting apparatus for the purchase of services according to claim 13, wherein the funds are provided by the purchaser of services.
